(19) United States
(12) Patent Application Publication
(10) Pub. No.: US 2021/0087872 A1
(43) Pub. Date: Mar. 25, 2021

(54) LOW THERMAL CONDUCTIVITY METAL-POLYMER-METAL SANDWICH COMPOSITE SPACER SYSTEM FOR VACUUM INSULATED GLASS (VIG) UNITS, VIG UNITS INCLUDING COMPOSITE SPACERS, AND METHODS OF MAKING THE SAME

(71) Applicant: GUARDIAN GLASS, LLC, Auburn Hills, MI (US)

(72) Inventors: Jason BLUSH, Auburn Hills, MI (US); Jason E. THEIOS, Auburn Hills, MI (US); Timothy J. FREY, Auburn Hills, MI (US)

(73) Assignee: GUARDIAN GLASS, LLC, Auburn Hills, MI (US)

(21) Appl. No.: 16/578,421

(22) Filed: Sep. 23, 2019

(51) Int. Cl. E06B 3/663; E06B 3/66; B32B 17/06

(52) U.S. Cl. CPC E06B 3/66304; B32B 2307/302; B32B 17/061; E06B 3/6612

(57) ABSTRACT

Certain example embodiments of this invention relate to vacuum insulated glass (VIG) units, and/or methods of making the same. A composite spacer system design helps improve VIG unit thermal performance by replacing high thermal conductivity spacers with composite designs. Decreasing the thermal conductivity of the spacer system can dramatically increase the center of glass R-value of the VIG unit. Certain example embodiments incorporate as spacers in a spacer system a low thermal conductivity metal-polymer-metal sandwich composite that benefits from a low thermal conductivity polymer (such as, for example, polyimide, polyamide, polyether ether keytone, or the like) in combination with the mechanical strength of metal or metallic top and bottom layers (e.g., formed from stainless steel, titanium, or the like).

### TECHNICAL FIELD

Certain example embodiments of this invention relate to vacuum insulated glass (VIG) units, and/or methods of making the same. More particularly, certain example embodiments of this invention relate to a low thermal conductivity composite spacer system design for VIG units, a VIG unit subassembly including a composite spacer system design, a VIG unit including a composite spacer system design, and/or associated methods.

### BACKGROUND AND SUMMARY

Vacuum insulating glass (VIG) units typically include at least two spaced apart glass substrates that enclose an evacuated or low-pressure space/cavity therebetween. The substrates are interconnected by a peripheral edge seal and typically include spacers between the glass substrates to maintain spacing between the glass substrates and to avoid collapse of the glass substrates that may be caused due to the low pressure environment that exists between the substrates. Some example VIG configurations are disclosed, for example, in U.S. Pat. Nos. 5,657,607, 5,664,395, 5,902,652, 6,506,472 and 6,383,580 the disclosures of which are all hereby incorporated by reference herein in their entireties.

FIGS. 1-2 illustrate a typical VIG unit 1 and elements that form the VIG unit 1. For example, VIG unit 1 may include two spaced apart substantially parallel glass substrates 2, 3, which enclose an evacuated low-pressure space/cavity 6 therebetween. Glass sheets or substrates 2,3 are interconnected by a peripheral edge seal 4 which may be made of fused solder glass, for example. An array of support pillars/spacers 5 may be included between the glass substrates 2, 3 to maintain the spacing of substrates 2, 3 of the VIG unit 1 in view of the low-pressure space/gap 6 present between the substrates 2, 3.

A pump-out tube 8 may be hermetically sealed by, for example, solder glass 9 to an aperture/hole 10 that passes from an interior surface of one of the glass substrates 2 to the bottom of an optional recess 11 in the exterior surface of the glass substrate 2, or optionally to the exterior surface of the glass substrate 2. A vacuum is applied to pump-out tube 8 to evacuate the interior cavity 6 to a low pressure, for example, using a sequential pump down operation. After evacuation of the cavity 6, a portion (e.g., the tip) of the tube 8 is melted to seal the vacuum in low pressure cavity/space 6. The optional recess 11 may retain the sealed pump-out tube 8. Optionally, a chemical getter 12 may be included within a recess 13 that is disposed in an interior face of one of the glass substrates, e.g., glass substrate 2. The chemical getter 12 may be used to adsorb or bind with certain residual impurities that may remain after the cavity 6 is evacuated and sealed.

VIG units with fused solder glass peripheral edge seals 4 are typically manufactured by depositing glass frit, in a solution (e.g., frit paste), around the periphery of substrate 2 (or on substrate 3). This glass frit paste ultimately forms the glass solder edge seal 4. The other substrate (e.g., 3) is brought down on substrate 2 so as to sandwich spacers/pillars 5 and the glass frit solution between the two substrates 2, 3. The entire assembly including the glass substrates 2, 3, the spacers/pillars 5 and the seal material (e.g., glass frit in solution or paste), is then heated to a temperature of at least about 500 degrees C., at which point the glass frit melts, wets the surfaces of the glass substrates 2, 3, and ultimately forms a hermetic peripheral/edge seal 4.

After formation of the edge seal 4 between the substrates, a vacuum is drawn via the pump-out tube 8 to form low pressure space/cavity 6 between the substrates 2, 3. The pressure in space 6 may be produced by way of an evacuation process to a level below atmospheric pressure, e.g., below about 10⁻² Torr. To maintain the low pressure in the space/cavity 6, substrates 2, 3 are hermetically sealed. Small, high strength spacers/pillars 5 are provided between the substrates to maintain separation of the approximately parallel substrates against atmospheric pressure. As noted above, once the space 6 between substrates 2, 3 is evacuated, the pump-out tube 8 may be sealed, for example, by melting its tip using a laser or the like.

A typical process for installing the pump-out tube 8 in the hole or aperture 10 includes inserting a pre-formed glass pump-out tube 8 in an aperture/hole 10 that has previously been formed (e.g., by drilling) in one of the glass substrates 2. After the pump-out tube 8 has been seated in the aperture/hole 10, an adhesive frit paste is applied to the pump-out tube 8, typically in a region close to the opening of the hole 10 proximate an exterior surface of the glass substrate 2. As noted above, the pump-out tube may be sealed after evacuation or purging of the VIG unit cavity.

After evacuation of the cavity to a pressure less than atmospheric, sealing of the pump-out tube may be accomplished by heating an end of the pump-out tube that is used to evacuate or purge the cavity to melt the opening and thus seal the cavity of the VIG unit. For example and without limitation, this heating and melting may be accomplished by laser irradiation of the tip of the pump-out tube.

VIG units are subject to extremely large static and dynamic loading, as well as stresses that are thermally-induced both during manufacturing (e.g., during pump down and thermal seal processing) and throughout service life (e.g., during wind-loads or mechanical and thermal shocks). The pillar spacers used to mechanically support the gap between the two substrates tend to indent the glass surfaces with which they in contact, thereby creating indented areas from which cracks may propagate and hence weaken the glass structure. The glass region just above the pillar has been found to be under compressive stress, whereas the peripheral region of the pillar has been found to be under tensile stress. It has been found that it is in the tensile regime that annealed glass is at its weakest state, and it has been found that any surface and bulk flaws in the tensile stress field may develop into cracks that may propagate. The magnitude of the tensile stress component increases with the inter-pillar spacing, and the likelihood of the cracks forming and ensuing catastrophic breakage increases once the stress field is above the strength of the glass. The surface profile or contour of the pillar may be related to the likelihood of any kind of Hertzian or coin shaped cracks.

One way to mitigate the indentation crack issue (e.g., while still being aggressive on pillar spacing) is to use glass that has been tempered such that the surface skin of the glass is in a highly compressive stress that tends to “wash out” the tensile stress components induced by supporting pillars. Unfortunately, however, VIG unit fabrication process steps take place at high temperatures and involve a thermal cycle duration that potentially can de-temper the glass.

Moreover, a recent thermal analysis study that better includes the spacer material into the R-value calculation discovered that the pillar array is a significant bottleneck to improved VIG performance, including insulating performance (measured, for example, as the R-value). In this regard, FIG. 3 is a thermal image of a VIG unit. It can be seen from FIG. 3 that the pillars are a significant source of heat loss in the VIG unit sample.

The sample used in FIG. 3 included stainless steel pillars. Stainless steel pillars have a thermal conductivity of 12 W/mK, and the overall R-value of the FIG. 3 sample had an R-value of 12. By contrast, ceramic pillars have significantly lower thermal conductivities. For instance, a typical ceramic pillar could have a thermal conductivity of 2.5 W/mK. As a result, changing the pillar from a stainless steel material to a ceramic material may increase the R-value. Indeed, original calculations of the R-value predicted that this change in pillar material would increase the R-value from 12-14. Further process and/or material improvements could result in an R-value of from 12 to possibly 20.

Unfortunately, however, ceramic pillars have low glass transition temperatures and therefore may not be able to survive high-temperature processes associated with VIG unit manufacturing in many instances. Ceramic pillars also may not have the strength to survive strong mechanical loads caused by manufacturing, transportation, installation, and/or other processes, or possibly wind or other loads to which the VIG unit may be exposed in its service life.

Thus, it will be appreciated that it would be desirable to provide a VIG unit with a spacer system design that addresses the above-described and/or other issues. For instance, it will be appreciated that it would be desirable to provide a VIG unit with a spacer system design that is mechanically strong, has a high glass transition temperature, and has a low thermal conductivity.

One aspect of certain example embodiments relates to a VIG unit with a spacer system design that possesses these and/or other advantageous properties.

Another aspect of certain example embodiments relates to a composite spacer system design in which outermost layers of the spacers are metal or metallic layers and at least one polymer-based layer is provided therebetween. For instance, certain example embodiments involve a spacer system design that have alternating layers of metal (or metallic material) and polymer such that the outermost layers are metal or metallic layers and such at least one polymer layer is provided therebetween.

Advantageously, the metal or metallic layer(s) help(s) with strain that otherwise would be applied to the polymer and provides mechanical strength to the polymer, the polymer helps provide a thermal break and therefore increases the R-value of the VIG unit, and the composite as a whole helps improve yield of the VIG units as the pillars are strong but somewhat flexible and thus the VIG units are less likely to form cracks, etc.

Pillars are not tempered (applied after temper) and will only survive edge fusing if they have a high enough Tg.

Another aspect of certain example embodiments relates to a VIG unit with an R-value of at least 14, more preferably at least 18, still more preferably at least 20, and possibly at least 30 (e.g., with an R-value from 14-40 in certain example embodiments).

Certain example embodiments relate to a method of making a VIG. First and second glass substrates are provided in substantially parallel spaced apart relation to one another such that a gap is formed therebetween, with a plurality of spacers being provided on the second glass substrate, and with each of the spacers including metal-inclusive outermost layers sandwiching at least one polymer-based layer. The first and second substrates are sealed together in connection with a frit material provided around peripheral edges of the first and/or second substrates. The gap is evacuated to a pressure less than atmospheric via a pump-out port. The pump-out port is sealed in making the VIG unit.

Certain example embodiments relate to a VIG unit, comprising: first and second glass substrates in substantially parallel spaced apart relation to one another such that a gap is formed therebetween, the gap being evacuated to a pressure less than atmospheric; an edge seal; and a plurality of spacers provided between the first and second substrates, each of the spacers including metal-inclusive outermost layers sandwiching at least one polymer-based layer.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a cross-sectional schematic diagram of a conventional vacuum insulated glass (VIG) unit;

FIG. 2 is a top plan view of a conventional VIG unit;

FIG. 3 is a thermal image of a VIG unit incorporating stainless steel pillars and demonstrating that heat loss occurs proximate the stainless steel pillar locations;

FIG. 4 is a partial cross-sectional view of a VIG unit incorporating a spacer system with a first composite spacer type in accordance with certain example embodiments;

FIG. 5 is a partial cross-sectional view of a VIG unit incorporating a spacer system with a second composite spacer type in accordance with certain example embodiments; and

FIG. 6 is a flowchart showing a process for making a VIG unit in accordance with certain example embodiments.

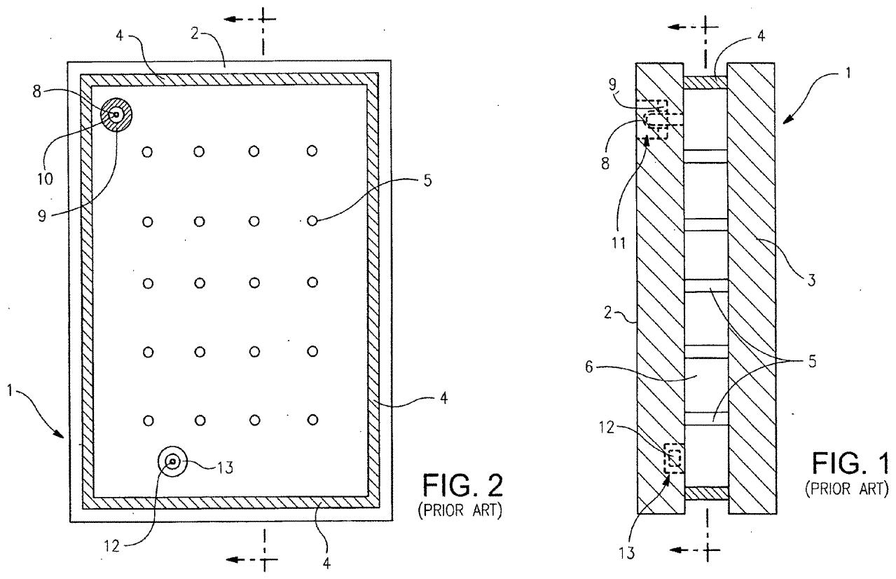

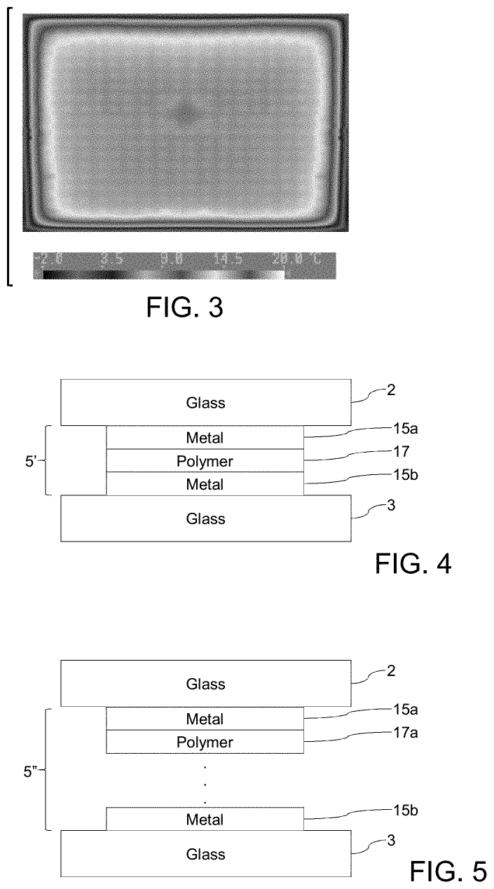

### DETAILED DESCRIPTION

Certain example embodiments relate to a low thermal conductivity composite spacer system design for vacuum insulated glass (VIG) units, a VIG unit subassembly including a composite spacer system design, a VIG unit including a composite spacer system design, and/or associated methods. The composite spacer system design helps improve VIG unit thermal performance by replacing high thermal conductivity spacers (currently, typically formed from stainless steel) with composite designs. Decreasing the thermal conductivity of the spacer system can dramatically increase the center of glass R-value of the VIG unit. Certain example embodiments thus incorporate as spacers a low thermal conductivity metal-polymer-metal sandwich composite that benefits from a low thermal conductivity polymer (such as, for example, polyimide, polyamide, polyether ether keytone, or the like) in combination with the mechanical strength of metal or metallic top and bottom layers (e.g., formed from stainless steel, titanium, or the like).

An example is provided in which the thermal conductivity of the composite pillars is 0.143 W/mK, which translates to a VIG unit with a center of glass R-value of 28. By contrast, a VIG unit with stainless steel pillars (with a thermal conductivity of 14 W/mK) with the same shape and configuration will have R-value of 12. Further improvements in pillar thermal resistance may in some instances significantly improve this R-value to greater than 30. This significant change in R-value would place a VIG unit closer in thermal performance to a highly-insulated wall system.

Referring now more particularly to the drawings in which like reference numerals indicate like parts throughout the several views, FIG. 4 is a partial cross-sectional view of a VIG unit incorporating a spacer system with a first composite spacer type in accordance with certain example embodiments. The VIG unit includes first and second substrates 2, 3. The FIG. 4 cross-sectional view is partial, as the spacer system will include a plurality of spaced-apart spacers 5′ that are provided across substantially all of the VIG unit.

The example spacer 5′ shown in FIG. 4 includes a metal-polymer-metal sandwich composite. The polymer-based layer 17 is sandwiched between upper and lower metal or metallic layers 15a, 15b. The polymer-based layer 17 provides a low thermal conductivity layer in the spacer 5′, which may be thought of as providing a “thermal break” between the upper and lower metal or metallic layers 15a, 15b. The upper and lower metal or metallic layers 15a, 15b provide additional strength to the spacer 5′. In certain example embodiments, the metal or metallic layers 15a, 15b cover a majority of the surface area of the spacer 5′, which is advantageous because the polymer in the polymer-based layer 17 might otherwise suffer from outgassing in the vacuum environment, e.g., as heat builds up therein while the VIG unit is in service, while a VIG unit subassembly is being processed (e.g., during pump-down, port sealing, and/or other processes), etc.

Sandwich composites can provide for many advantages by means of integrating the properties of each material in the sandwich. For example, polymer-based materials combined with metal or metallic materials are lightweight but nonetheless strong. It is possible to tailor the properties of the individual spacers by choosing the accurate combination of materials (e.g., the combination of mono-materials), thus providing functionality to fulfill the demands of the spacer. For example, more metal or metallic material may be provided where increased strength is desired, more polymer-based material may be provided where increased thermal performance is desired, etc.

The metal-polymer-metal sandwich composite 5′ shown in FIG. 4 may be thought of as using the polymer-based layer 17 as a substrate supporting the upper and lower metal or metallic layers 15a, 15b. Polymers have extremely low thermal conductivities. Thermal conductivity is less than or equal to 5 W/mK, preferably less than or equal to 1 W/mK, more preferably less than or equal to 0.5 W/mK, still more preferably less than or equal to 0.25 W/mK, and sometimes 0.12 W/mK or even lower. The following table lists types of polymers, along with their compressive yield strength and compressive modulus values. In general, a strong compressive yield strength is desirable, with values of at least 100 MPa being preferred, at least 130 MPA being more preferred, and at least 150 MPA being still more preferred.

| | Compressive Yield | Compressive |
|---|---|---|
| Polymer Type | Strength (MPa) | Modulus (GPa) |
| ABS | 65 | 2.5 |
| ABS + 30% Glass Fiber | 120 | 8 |
| Acetal Copolymer | 85 | 2.2 |
| Acetal Copolymer + | 100 | 7.5 |
| 30% Glass Fiber | | |
| Acrylic | 95 | 3 |
| Nylon 6 | 55 | 2.3 |
| Polyamide-Imide | 130 | 5 |
| Polycarbonate | 70 | 2.0 |
| Polyether Ether Keytone | 120 | 3.4 |
| (PEEK) | | |
| Polyethylene, HDPE | 20 | 0.7 |
| Polyethylene | 80 | 1 |
| Terephthalate (PET) | | |
| Polyimide | 150 | 2.5 |
| Polyimide + | 220 | 12 |
| Glass Fiber | | |
| Polypropylene | 40 | 1.5 |
| Polystyrene | 70 | 2.5 |

During VIG unit processing, VIG unit subassemblies typically are heated to about 400 degrees C. It therefore would be desirable to provide a substrate with a glass transition temperature (Tg) sufficiently high to survive these high temperature processes. In general, materials with a Tg of greater than 125 degrees C. are preferred, materials with a Tg of greater than 200 degrees C. are more preferred, materials with a Tg of greater than 250 degrees C. are still more preferred, and materials with a Tg of greater than 350 degrees C. are still more preferred. It will be appreciated that the composite pillars in their respective entireties preferably have Tg values equal to or higher than these enumerated ranges. For instance, the composite pillars in their respective entireties have Tg values of 250-500 degrees C., more preferably 350-500 degrees C., in certain example embodiments.

Polyimide (PI or Kapton) and Polyether Ether Keytone (PEEK). generally have sufficiently high compressive yield strengths compared to other polymers. PEEK has a Tg of about 150 degrees C., whereas PI has an relatively high Tg of about 370 degrees C. PI and PEEK materials therefore may be used in connection with certain example embodiments, although other materials are possible in different instances.

A low thermal conductivity pure metal or alloy is used to reduce the thermal conductivity of the spacer and to provide additional compressive strength to the system compared to the polymer by itself. The following table shows the thermal conductivity and compressive yield strengths of different materials. Note that the PEEK and PI entries are provided for comparison purposes.

| | Thermal | | Compressive |
|---|---|---|---|
| Material | Conductivity | | Yield Strength |
| Stainless Steel (304) | 16 | W/mK | 101,500 psi |
| Titanium (6-4) | 12 | W/mK | 141,000 psi |
| Hastelloy C276 | 10 | W/mK | 163,000 psi |
| PEEK | 0.25 | W/mK | 17,100 psi |
| Kapton PI | 0.12 | W/mK | 21,000 psi- |
| | | | 32,000 psi |
| | | | (glass filled) |

As can be seen from the table above, the metal or metallic materials have very high compressive yield strengths compared to the example polymer materials, but sacrifice thermal conductivity. That said, the sandwich approach is advantageous because it includes the polymer-based substrates that serve as a low thermal conductivity material and thermal break in a substantial portion of the spacer design.

In addition to providing strength for the spacers, the presence of metal or metallic layers is advantageous because, as noted above, the layers cover surfaces of the polymer, thereby reducing the amount of surface area of the polymer-based layer exposed to the vacuum atmosphere where it might otherwise outgas and degrade the quality of the VIG unit.

In general, the metal or metallic layers of certain example embodiments may comprise or consist essentially of titanium, stainless steel, Hastelloy C276, nickel, and/or the like, although other materials may be used in place of or in addition to these materials. It will be appreciated that the top and bottom layers may be the same or different materials, in different example embodiments. As is known, Hastelloy C276 is a nickel-molybdenum-chromium alloy with an addition of tungsten, designed to have excellent corrosion resistance in a wide range of severe environments.

FIG. 5 is a partial cross-sectional view of a VIG unit incorporating a spacer system with a second composite spacer type in accordance with certain example embodiments. FIG. 5 is similar to FIG. 4, except that its spacer 5″ includes additional metal or metallic and polymer-based layers. That is, an upper metal or metallic layer 15a is provided adjacent the first glass substrate 2, and a lower metal or metallic layer 15b is provided adjacent the second glass substrate 3. An upper polymer-based layer 17a is provided on a side of the upper metal or metallic layer 15a opposite the first glass substrate 2. One or more sub-stacks of metal or metallic/polymer-based layers may be provided between the upper polymer-based layer 17a and the lower metal or metallic layer 15b. The material selected for the polymer-based layers may be uniform throughout the spacer 5″ in certain example embodiments, although other example embodiments may use two or more different materials for the polymer-based layers therein. Similarly, the material selected for the metal or metallic layers may be uniform throughout the spacer 5″ in certain example embodiments, although other example embodiments may use two or more different materials for these layers. In certain example embodiments, a five-layer stack of metal/polymer/metal/polymer/metal may be provided.

As will be appreciated from the above, sandwich materials can be formed with numerous different kinds of top/bottom layers metal or metallic layer materials and core polymer-based materials. Sandwiches may be formed by bonding materials together using an adhesive agent in processes such as, for example, lamination, roll-bonding, heat press joining, and/or the like. Additionally, the metal or metallic layer(s) may be applied to the polymer-based substrate via sputtering, plating, or the like. For instance a sheet of polymer-based material may have a metal or metallic material sputter deposited, plated, or otherwise formed thereon, and that sheet may be cut or otherwise separated into discrete spacers, which may be pillar- or other-shaped.

The thermal conductivity of a metal-polymer-metal sandwich pillar was calculated using the parameters seen in the following table. As can be seen from that table, calculations revealed that a Ti-PI-Ti pillar (with Kapton as the polyimide) had a thermal conductivity of 0.142 W/mK. The calculated value compares favorably to the thermal conductivity of the equivalent stainless steel pillar which, as noted above, is 14 W/mK.

| | | Thermal | Layer |
|---|---|---|---|
| | | Conductivity | Resistance |
| Layer | Thickness (m) | (W/mK) | (C/W) |
| Top Layer -Ti | 0.000024 | 12 | 6.522292994 |
| Ka prop | 0.000254 | 0.12 | 6902.760085 |
| Bottom Layer-Ti | 0.000024 | 12 | 6.522292994 |
| | Total | Thermal Cond | |
| Stack | Resistance (C/W) | of Pillar (W/mK) | |
| Ti-PI-Ti | 6915 | 0.1424 | |

The pillars' calculated thermal conductivity was then imported into a VIG R-value calculator to determine its effect on the thermal performance of a VIG unit, based on the parameters provided in the following table.

| VIG Parameter | Value |
|---|---|
| Pillar Height | 0.300 mm |
| Pillar Diameter | 0.625 mm |
| Pillar Spacing | 40 mm |
| Temp (in-air) | 20 degrees C. |
| Temp (out-air) | −18 degrees C. |
| Vacuum Pressure | 1 × 10⁻⁶ Pa |
| Glass Thickness | 3 mm |

The performance of a VIG unit including Ti-PI-Ti sandwiched composite pillars significantly outperforms a VIG unit including equivalent stainless steel pillars. That is, VIG unit including Ti-PI-Ti sandwiched composite pillars was determined to have an R-value of 28, which has a significantly better thermal performance of a VIG unit including equivalent stainless steel pillars with its R-value of 12.

In certain example embodiments, thermal conductivity of the composite pillar is less than or equal to 5 W/mK, preferably less than or equal to 1 W/mK, more preferably less than or equal to 0.5 W/mK, still more preferably less than or equal to 0.25 W/mK, and sometimes 0.15 W/mK or even lower.

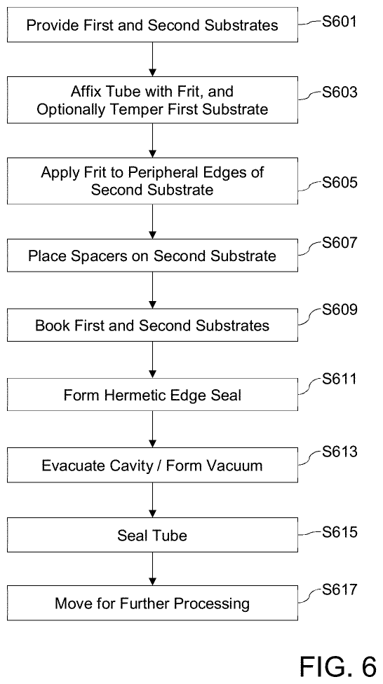

FIG. 6 is a flowchart showing a process for making a VIG unit in accordance with certain example embodiments. In step S601, first and second substrates are provided. A pump-out tube is affixed to the first substrate in connection with a pump-out port, in step S603. Optionally, the first substrate may be tempered with the pump-out tube therein. In step S605, frit is applied to peripheral edges of the second substrate. Composite spacers are placed on the second substrate in step S607. The first and second substrates are booked together in step S609. An hermetic edge seal is formed in step S611, e.g., by pre-heating the VIG unit subassembly via an oven or the like and then applying localized heat around the peripheral edges of the VIG unit subassembly. The cavity is evacuated in step S613, thereby forming a vacuum in the space between the first and second substrates. The tube is sealed in step S615 in making the VIG unit, and the VIG unit is moved for further processing in step S617.

It will be appreciated that the spacer system may include pillar-shaped and/or otherwise shaped spacers, in different example embodiments. It also will be appreciated that some of the spacers in a given spacer system may be composite spacers, whereas other may not be. For instance, metal or metallic spacers may be provided in an area expected to receive more loading (e.g., proximate to the center of the VIG unit) and composite spacers may be provided elsewhere. As another example, a spacer system may incorporate a pattern of alternating monolithic and composite spacers. That example may include rows with one or more metal or metallic spacers followed one or more composite spacers. These arrangements may still help improve the performance of the VIG units while potentially providing increased strength to an area or areas of the VIG units (or to the VIG units in their respective wholes).

It will be appreciated that techniques disclosed herein may be used in a wide variety of applications including for example, in VIG window applications, merchandizers, laminated products, hybrid VIG units (e.g., units where a substrate is spaced apart from a VIG unit via a spacer system), etc.

The terms “heat treatment” and “heat treating” as used herein mean heating the article to a temperature sufficient to achieve thermal tempering and/or heat strengthening of the glass inclusive article. This definition includes, for example, heating a coated article in an oven or furnace at a temperature of at least about 550 degrees C., more preferably at least about 580 degrees C., more preferably at least about 600 degrees C., more preferably at least about 620 degrees C., and most preferably at least about 650 degrees C. for a sufficient period to allow tempering and/or heat strengthening. This may be for at least about two minutes, or up to about 10 minutes, in certain example embodiments. These processes may be adapted to involve different times and/or temperatures.

As used herein, the terms “on,” “supported by,” and the like should not be interpreted to mean that two elements are directly adjacent to one another unless explicitly stated. In other words, a first layer may be said to be “on” or “supported by” a second layer, even if there are one or more layers therebetween.

In certain example embodiments, a method of making a vacuum insulated glass (VIG) unit is provided. First and second glass substrates are provided in substantially parallel spaced apart relation to one another such that a gap is formed therebetween, with a plurality of spacers being provided on the second glass substrate, and with each of the spacers including metal-inclusive outermost layers sandwiching at least one polymer-based layer. The first and second substrates are sealed together in connection with a frit material provided around peripheral edges of the first and/or second substrates. The gap is evacuated to a pressure less than atmospheric via a pump-out port. The pump-out port is sealed in making the VIG unit.

In addition to the features of the previous paragraph, in certain example embodiments, the at least one polymer-based layer may comprise polyimide.

In addition to the features of either of the two previous paragraphs, in certain example embodiments, each metal inclusive layer may comprise titanium.

In addition to the features of any of the three previous paragraphs, in certain example embodiments, the spacers may have a thermal conductivity of less than or equal to 0.5 W/mK (e.g., less than or equal to 0.25 W/mK).

In addition to the features of any of the four previous paragraphs, in certain example embodiments, the spacers may be formed by sputter depositing the metal-inclusive material on a substrate formed of the material in the polymer-based layer, plating the metal-inclusive material on a substrate formed of the material in the polymer-based layer, and/or the like.

In addition to the features of any of the five previous paragraphs, in certain example embodiments, the metal-inclusive outermost layers may directly contact the first and second substrates.

In addition to the features of any of the six previous paragraphs, in certain example embodiments, the spacers further may comprise at least one sub-stack including a further metal-inclusive layer adjacent to a further polymer-based layer.

In addition to the features of the previous paragraph, in certain example embodiments, the spacers may include alternating metal-inclusive and polymer-based layers.

In addition to the features of either of the two previous paragraphs, in certain example embodiments, the spacers may comprise a plurality of sub-stacks, e.g., with each including a further metal-inclusive layer adjacent to a further polymer-based layer.

In addition to the features of any of the nine previous paragraphs, in certain example embodiments, the spacers may have a glass transition temperature of greater than 350 degrees C.

In addition to the features of any of the ten previous paragraphs, in certain example embodiments, the VIG unit has an R-value of at least 20.

In certain example embodiments, a vacuum insulated glass (VIG) unit is provided. First and second glass substrates are in substantially parallel spaced apart relation to one another such that a gap is formed therebetween, with the gap being evacuated to a pressure less than atmospheric. An edge seal is provided. A plurality of spacers is provided between the first and second substrates, with each of the spacers including metal-inclusive outermost layers sandwiching at least one polymer-based layer.

In addition to the features of the previous paragraph, in certain example embodiments, the at least one polymer-based layer may comprise polyimide or polyether ether keytone.

In addition to the features of either of the two previous paragraphs, in certain example embodiments, each metal inclusive layer may comprise titanium, stainless steel, and/or nickel.

In addition to the features of any of the three previous paragraphs, in certain example embodiments, the spacers may have a thermal conductivity of less than or equal to 0.25 W/mK.

In addition to the features of any of the four previous paragraphs, in certain example embodiments, the metal-inclusive outermost layers may directly contact the first and second substrates.

In addition to the features of any of the five previous paragraphs, in certain example embodiments, the spacers may further comprise at least one sub-stack including a further metal-inclusive layer adjacent to a further polymer-based layer.

In addition to the features of any of the six previous paragraphs, in certain example embodiments, the spacers may comprise a plurality of sub-stacks each including a further metal-inclusive layer adjacent to a further polymer-based layer.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of making a vacuum insulated glass (VIG) unit, the method comprising:
providing first and second glass substrates in substantially parallel spaced apart relation to one another such that a gap is formed therebetween, a plurality of spacers being provided on the second glass substrate, each of the spacers including metal-inclusive outermost layers sandwiching at least one polymer-based layer;
sealing together the first and second substrates in connection with a frit material provided around peripheral edges of the first and/or second substrates;
evacuating the gap to a pressure less than atmospheric via a pump-out port; and
sealing the pump-out port in making the VIG unit.

2. The method of claim 1, wherein the at least one polymer-based layer comprises polyimide.

3. The method of claim 1, wherein each metal inclusive layer comprises titanium.

4. The method of claim 1, wherein the spacers have a thermal conductivity of less than or equal to 0.5 W/mK.

5. The method of claim 1, wherein the spacers have a thermal conductivity of less than or equal to 0.25 W/mK.

6. The method of claim 1, wherein the spacers are formed by sputter depositing the metal-inclusive material on a substrate formed of the material in the polymer-based layer.

7. The method of claim 1, wherein the spacers are formed by plating the metal-inclusive material on a substrate formed of the material in the polymer-based layer.

8. The method of claim 1, wherein the metal-inclusive outermost layers directly contact the first and second substrates.

9. The method of claim 1, wherein the spacers further comprise at least one sub-stack including a further metal-inclusive layer adjacent to a further polymer-based layer.

10. The method of claim 9, wherein the spacers include alternating metal-inclusive and polymer-based layers.

11. The method of claim 9, wherein the spacers comprise a plurality of sub-stacks each including a further metal-inclusive layer adjacent to a further polymer-based layer.

12. The method of claim 1, wherein the spacers have a glass transition temperature of greater than 350 degrees C.

13. The method of claim 1, wherein the VIG unit has an R-value of at least 20.

14. A vacuum insulated glass (VIG) unit, comprising:
first and second glass substrates in substantially parallel spaced apart relation to one another such that a gap is formed therebetween, the gap being evacuated to a pressure less than atmospheric;
an edge seal; and
a plurality of spacers provided between the first and second substrates, each of the spacers including metal-inclusive outermost layers sandwiching at least one polymer-based layer.

15. The VIG unit of claim 14, wherein the at least one polymer-based layer comprises polyimide or polyether ether keytone.

16. The VIG unit of claim 14, wherein each metal inclusive layer comprises titanium, stainless steel, and/or nickel.

17. The VIG unit of claim 14, wherein the spacers have a thermal conductivity of less than or equal to 0.25 W/mK.

18. The VIG unit of claim 14, wherein the metal-inclusive outermost layers directly contact the first and second substrates.

19. The VIG unit of claim 14, wherein the spacers further comprise at least one sub-stack including a further metal-inclusive layer adjacent to a further polymer-based layer.

20. The VIG unit of claim 14, wherein the spacers comprise a plurality of sub-stacks each including a further metal-inclusive layer adjacent to a further polymer-based layer.
